(19) United States
(12) Patent Application Publication
(10) Pub. No.: US 2023/0166324 A1
(43) Pub. Date: Jun. 1, 2023

(54) LASER POST-TREATMENT OF METAL EFFECT PIGMENT SURFACES TO LOCALLY INCREASE RADAR AND/ OR LIGHT TRANSMISSION

(71) Applicant: SCHLENK METALLIC PIGMENTS GMBH, Roth (DE)

(72) Inventor: Frank Jochen Maile, Roth (DE)

(21) Appl. No.: 18/094,566

(22) Filed: Jan. 9, 2023

Related U.S. Application Data
(63) Continuation of application No. PCT/DE2021/100605, filed on Jul. 11, 2021.

(30) Foreign Application Priority Data
Jul. 11, 2020 (DE) 102020118344.5

(51) Int. Cl. B22F 1/05; B22F 1/142

(52) U.S. Cl. CPC B22F 1/05; B22F 1/142

(57) ABSTRACT

Post-treatment method and/or fine patterning method of effect pigment-containing or metal-containing particle-containing objects, for example car body parts or cosmetic containers or layers, for example paint layers or printing ink layers, by means of energy input (e.g. heat input, preferably by laser light), whereby the hiding power of metal-containing pigment platelets or metal-containing particles is permanently reduced by their change in shape factor. In the treated surfaces, this change in shape factor causes a permanent local increase in transparency, translucency or transmission for electromagnetic waves, in particular radar wave, radio wave and/or light wave transmission, and/or a local reduction in reflectance, for example for the production of painted radomes. The process differs from conventional laser marking in that the transmission for electromagnetic waves of normally reflective metal-effect pigment surfaces or metal-containing particles is permanently increased by the change in shape factor caused by the laser beam, whereby pigment platelets or particles are changed either by direct melting and/or by triggering an auxiliary chemical reaction in such a way that their metal core is at least partially melted, possibly chemically transformed and/or destroyed.

The present invention relates to a marking method and/or fine patterning method of metal effect pigment surfaces, interference metal effect pigment surfaces and pigment-containing articles for permanent local increase of transparency, translucency or transmission for electromagnetic waves, in particular radar waves, radio waves and/or light waves, and/or local reduction of reflectance.

The present invention also relates to the products of the method, e.g. plastic body parts painted with metallic effect pigments that have been made more transparent to radar waves, objects such as cosmetic bottles or automotive controls, and cell phones that have been subsequently labeled with transparent, translucent or backlit symbols.

Likewise, the present invention relates to the use of suitable metal effect pigments or metal-containing particles with thin metal layers, as well as printing inks, varnishes, masterbatches and interference metal effect pigments to carry out the method. The invention also relates to articles containing such suitable particles, or pigments, and optimized or intended for application of the method, for example by using suitable laser-sensitive fillers that promote chemical reaction or physical deformation of the metal portion of the pigments or metal-containing particles.

### STATE OF THE ART

The automotive industry is increasingly using radar sensors in vehicles. To enable autonomous driving in the future, radar sensors must be mounted all around the vehicle. Therefore, these radar sensors must be mounted behind plastic body parts that are painted in the vehicle color.

Metal effect pigments as part of the basecoat are widely used in automotive coatings, and are in high demand by customers.

Unfortunately, these metal effect pigments cause both reflections of radar beams and safety-relevant changes in the directional characteristics of radar antennas. In particular, the location of an obstacle can be severely distorted as a result, because the radiation angle of the antenna is altered by the coating. The falsification also depends on the color of the car and the amount of metal in the coating. A major problem exists in particular in the repair of originally painted automotive parts after paint damage, since the process of (mostly manual) refinishing allows only insufficient control over the paint layer thickness parameter, which is important for radar transmission.

For a long time, attempts have been made to find solutions to this problem, but so far largely without success.

These problems were competently explained in DE102014222837A1 and were quantified in the dissertation by F. Pfeiffer, “Analysis and Optimization of Radomes for Automotive Radar Sensors,” Technical University of Munich 2010.

The problem of interference of radar beams for millimeter waves in the frequency range around 75 GHz by different metal pigment basecoats was measured and clarified, for example, in Table 4.5, page 46 of the said dissertation. The metal content seems to play a major role.

In particular, high metal content (e.g. light silver metallic) in the basecoat of a curved body part causes high reflections of the radar beam, which cause strong distortions of the directional characteristic of the antenna, attenuation, as well as a distortion of the radiation angle.

TABLE 4.5
Metal content and relative permitivity of the basecoats investigated

| color basecoat | | |
|---|---|---|
| weight-% | metal content | rel. permitivity εr |
| black uni | 0 | 1.8 |
| black pearl effect | 0 | 2.2 |
| black pearl effect (LM) | 0 | 2.0 |
| white pearl effect dark | 0 | 5.5 |
| green pearl effect | 0 | 2.1 |
| dark blue uni | 0.01 | 2.0 |
| gray pearl effect | 0.64 | 5.3 |
| beige metallic | 0.96 | 17.8 |
| dark gray pearl effect | 1.43 | 13.1 |
| dark silver metallic | 2.1 | 19.8 |
| gray metallic | 2.66 | 26.5 |
| light silver metallic | 3.66 | 52.5 |
| silver metallic | 4.08 | 47.5 |
| light silver metallic (LM) | 4.38 | 49.5 |

LM: solvent based/not specified: water based

The solution proposed by the author, to add an inductive or capacitive device that at least partially compensates for a reflection of the electromagnetic radiation (5) of the radar sensor caused by the paint layer, was patented under EP2151889A1 (Audi AG).

However, this prior art solution (similar to an oscillating circuit) must be carefully adapted depending on the paint and layer thickness.

The dual paint method even requires that the thickness of the bumper be made dependent on the paint used, which causes problems in the automotive industry.

Furthermore, this solution is not broadband enough and hardly suitable for wider radar viewing angles.

Another disadvantage of the prior art solution for the automotive industry is the necessary optimization depending on the pigment/paint system and the paint thickness. Production problems would thus be pre-programmed depending on the color of the car.

Repainting, for example after a scratch in the area of the radome, also becomes problematic and, depending on the shape of the body part housing the radome, has to be re-optimized by complex modeling. Overall, this is very problematic for car manufacturers who are looking for more of a universal solution.

Several radar manufacturers are therefore trying to use radars that can adapt themselves to the various metal pigment coatings as far as possible. In many cases, however, reliable adaptation is hardly possible, especially when the metal content of the basecoat is high.

According to DE102014222837A1 or DE102016001310A1, there is no attempt at all to change or reduce the influence of the paint, but to adaptively solve the problem of attenuation, reflections and antenna directivity characteristics and distortions by compensating control of the electronics.

Other documents such as EP1462817A1 teach to get the antenna directivity, distorted by unwanted reflections, back under control with absorbing materials. However, this does not lead to a paint-independent solution because directivity distortion and unwanted reflections are paint-dependent. The required absorption solutions would also be paint dependent.

From DE19819709A1, DE10026454C1 and DE102007059758A1 it is known to hide radars behind a metal layer which is so thin that it remains transparent to the radar waves and can serve as a radome although it reflects the light. The design of this metal layer in front of the radar antenna is up to the user, as long as it is thin enough (in practice, much thinner than the “skin depth” for radar waves, but much thicker than the “skin depth” for human-visible wavelengths). A 100 nm thin Daimler emblem in the middle of the radiator grille in front of a radar unit was given as an example.

An electromagnetic wave approaching a homogeneous metal surface perpendicularly is normally almost completely reflected, among other things because the surface is in principle equipotential if it is perfectly conductive. The electric field E in the metal is cancelled by its conductivity, as if there were a mutual wave with opposite field vector to the electric field vector.

In practice, however, the incoming wave is not directly weakened at the surface because the conductivity of the metal is not infinite, so the electric field component E of the electromagnetic wave is not immediately cancelled at the surface. Instead, the electric field component E penetrates a little deeper into the conductive material with the wave and is weakened there exponentially the deeper the wave penetrates. The penetration depth of the electromagnetic wave in a homogeneous metal depends on the inverse root of the frequency of the wave. At 300 nm depth in aluminum, only 37% of an incoming 76 GHz radar wave is present. In a dielectric paint layer containing aluminum platelets insulated from each other, exponential attenuation is also observed, but the attenuation is not as severe.

The metal pigment basecoat thickness commonly used in the automotive industry is color tone dependent and is about 15 microns and behaves almost like a homogeneous conductive metallization for radar waves because of the unavoidable stray capacitance between partially overlapping metal pigment platelets, which would be almost two orders of magnitude thicker than the maximum metallization thickness recommended according to the above teachings.

This phenomenon of stray capacitance between individual pigment platelets can also be explained as interfacial polarization.

Thicker metal elements in the path of the microwave must never be wider than lambda/10 (lambda=wavelength, i.e. 4 millimeters for a 76 GHz radar wave) according to the teachings of DE 19644164A1 (Bosch), so that they remain practically transparent to the microwaves. Thus, for a 76 GHz radar wave, any metal elements in front of the antenna must not exceed 0.4 millimeters in width.

However, this condition is only met for metal effect pigment platelets if they are far enough apart. This is not the case with conventional metal effect paints, however, because the metal pigment density in the basecoat matrix must be high enough to ensure sufficient hiding power, and this results in pigment overlaps. However, with the frequency of pigment overlaps, the scattering capacity and interfacial polarization also increase. With increasing pigment density, the coating behaves more and more like a homogeneous metal layer, since the pigments appear to be electrically connected to each other due to the stray capacitances at such high frequencies.

Since radar problems increase with the pigment content of a car paint, attempts have also been made to simulate metal-effect paints from low-metal pigment mixtures. In such blends, a larger proportion of pearlescent pigments is added to a small proportion of metal-effect pigments, the latter usually being unproblematic for radar waves because they are built on a dielectric, light-transmissive core. However, the admixture will inevitably make the overall visual impression of the painted parts look somewhat less metallic than conventional body panels, which is not necessarily desirable.

While these documents show that the problem of metallic paints is well known, they do not reveal a paint-independent solution for fully metallic-effect paints.

The automotive industry urgently needs a paint-independent and nearly invisible radar wave transmission solution that is compatible with full metal effect pigment paints, and that is also compatible with a variety of conventional painting processes (spray, dip, electrostatic, and many more).

### Problem and Solutions

Accordingly, the first objective of the invention relates to a process for increasing the transmission of radar waves in body parts painted with metal effect pigments or metal-containing particles, wherein interfering metal effect pigments or metal-containing particles in the path of the radar beams are eliminated in the finished painted body part in front of the radar sensors, preferably without marking or damaging the pigment-containing paint layer visible to the human eye.

Surprisingly, it has been shown that the increase in transmission for radar waves that can be achieved by the method according to the invention is also partly responsible for an increase in transmission for light waves as a side effect. In other words, the treated metal-effect-pigmented surface or interference-metal-effect-pigmented surface or generally the surface provided with metal-containing particles can become transparent or translucent, which enables further applications, such as the subsequent marking of transparent symbols or motifs on backlit control elements, reflective objects or cosmetic surfaces.

This results in a second, surprising but equally important objective of the method according to the invention, namely to make reflective metal effect pigments or metal-containing particles essentially transparent, translucent or invisible and hardly reflective any more by means of laser treatment.

Since the areas treated by the method become almost transparent, a third problem further arises, namely how to reduce the area affected by the treatment and make it so thin that it is not or hardly noticeable to the human eye and yet increases the transmission of radar waves.

From U.S. Pat. No. 3,975,738 (US Air Force, 1976, slotted radome for combat aircraft), for example, a suitable Y-aperture pattern is known which is intended to be transparent to any polarization of the radar wave.

Although the disclosure does not concern metal paints, but only homogeneous metal surfaces that must be made radar-wave permeable, the slotted-antenna teaching nevertheless appears to be applicable as a partial solution, and its applicability to laser-patterned metal-effect paints has been confirmed by experiments.

In particular, the wavelength-dependent optimized dimensions of a Y-slot are very clearly specified numerically precisely, especially the width of the lines to become transparent.

The slot width disclosed in U.S. Pat. No. 3,975,738 is 0.0175 lambda, at a wavelength of 4 millimeters this corresponds to a line width of 70 micrometers, which would be invisible to the human eye on the coating.

These dimensions are probably the result of a very careful optimization campaign for scanning attack radars, with the incidence of the radar wave on the radome constantly changing, which is also necessary for advanced radar technology on cars.

The problem(s) underlying the invention is/are solved by the method and the subject matter of the independent claims. The dependent claims represent preferred embodiments.

The object of the present invention is, inter alia, a method which solves the above-mentioned tasks, wherein a post-treatment of articles containing thin metal platelets or metal-containing particles is carried out by light input or heat input, preferably by a laser, in particular a pulsed Nd-YAG laser for laser marking, in order to achieve a subsequent physical or chemical change of the metal platelets or metal-containing particles in a dielectric matrix, whereby the hiding power of the metal platelets or metal-containing particles is permanently and markedly reduced and the transmission of the object for electromagnetic waves (light waves, radar waves, radio waves) is increased. The metal platelets can be metal effect pigments, interference metal effect pigments or metal-containing particles in general.

### FIGURES

FIG. 1 shows how the boundary polarization and scattering capacitance between metal pigments in a basecoat negatively affects radar wave transmission (dissertation by F. Pfeiffer, “Analysis and Optimization of Radomes for Automotive Radar Sensors,” Technical University of Munich 2010);

FIG. 2 shows the omnipolar slot arrangement and slot dimensions for metal radomes of a fighter aircraft recommended in U.S. Pat. No. 3,975,738 (prior art, US Air Force, 1976);

FIG. 3 shows the main features and effect examples of the various conventional laser marking processes as state of the art from the book Surface Technology, author: Dr. Feist;

FIG. 4 shows the post-treatment of a metal pigmented layer to increase transparency according to the present invention;

FIG. 5 shows images of changes in the shape of pigments laser-treated according to the present invention;

FIG. 6 shows the influence of decomposition of fillers responsible for the transformations and pigment remnants of FIG. 5;

FIG. 7 shows how interference metal effect pigments with thin cores are relatively fire resistant;

FIG. 8 shows how preferred Nd-YAG laser parameters are determined by test patterns;

FIG. 9 shows that the metal-effect pigments are usually no longer visible in the laser-labeled region, and not only directly on the surface;

FIG. 10 shows a test matrix for further determination of laser parameters for the invention, as well as some test results with different pulse spacings for a dark, low-dose “Chromos” metal effect pigment with a particularly thin aluminum core and silica protective layer;

FIG. 11 shows how the scattering parameters, in particular the input reflectance S11 and, if applicable, forward transmittance S21 of a laser-treated paint sample are measured experimentally with a network analyzer as a function of frequency in comparison with an untreated paint sample;

FIG. 12 shows how the scattering parameters, in particular the free-space input reflection S11 and, if applicable, free-space forward transmission S21 of a metal varnish slot radome prototype are measured experimentally with a network analyzer as a function of frequency in comparison to an untreated varnish sample;

FIG. 13 shows a detail of a slot radome prototype made of lasered interference metal effect pigment paint “Zenexo GoldenShine” with Y-slot profile on a plastic body part;

FIG. 14 shows a radome example with silver aluminum pigment AluStar, where the basecoat was lasered by 40 micrometer clearcoat;

FIG. 15 shows the experimentally measured reflectance S11 and transmittance S21 of the radome designs shown in FIG. 14, among others.

### DETAILED DESCRIPTION

The present invention relates to a post-treatment method and/or fine patterning method of metal pigment-containing objects, for example car body parts or cosmetic containers or layers, for example paint layers or printing ink layers, in which the hiding power of the metal-containing pigment platelets, for example metal effect pigments or interference metal effect pigments, is permanently reduced by means of heat input by changing their shape factor.

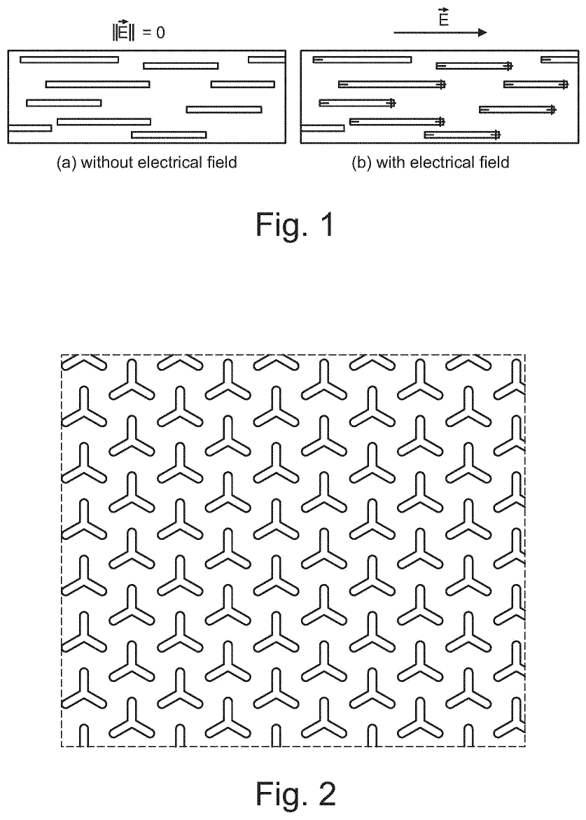

The present invention is important for the future of autonomous driving because metal-effect pigment-containing paints interfere with radar reception. As shown in FIG. 1, two overlapping metal pigments in the paint form a capacitor and are thus like electrically connected to each other for GHz frequencies. This is why a solution is so important to make the paint permeable to radar waves.

In the treated surfaces, this shape factor change causes a permanent local increase in transparency, translucency or transmission for electromagnetic waves, in particular radar waves, radio waves and/or light waves, and/or a local reduction in reflectance, for example for the production of inconspicuous metal-effect painted radomes in car color for radar sensors (millimeter waves).

The treated surfaces are also used for the production of backlit control elements in the cockpit of vehicles for the telecommunication industry for the production of radio wave transparent metal painted 5G transponders, in the cosmetics industry for the production of finely engraved transparent symbols on precious packaging or for the production of inconspicuous micro markings as security, copy protection, origin or authenticity guarantees of objects, for example bank bills, and many more.

An advantageous implementation of the method using a conventional laser unit 1 suitable for laser marking, for example Nd-YAG laser unit, for generating the heat input is shown in FIG. 4.

The laser unit 1 generates a laser beam 2 that irradiates a dielectric matrix 3, and which can be moved/scanned relative thereto. For example, the matrix 3 may be a laser light-transmissive basecoat of a metallized automotive paint, or the material of a cosmetic container, preferably made of transparent or translucent polypropylene or polyethylene.

Essentially, the matrix 3 contains metal effect pigment platelets 4 with such thin metal cores or metal layers in the intact state that they are preferably partially transparent to laser light.

Preferably, pigments based on vacuum metallized platelets (VMP) with a thin metal layer or metal core below 40 nm thickness can be used for this purpose, further preferably below 30 nm thickness, and even more advantageously below 20 nm thickness for better convertibility.

These pigments can have further layers, preferably laser light transparent layers, for example protective layers of alumina or silica, thicker interference layers, for example of iron oxide or chalcogenides, and/or layers to improve the adhesion or bonding ability of the platelets with the matrix, for example of silanes, preferably of alkylsilane.

However, it has been shown that further layers are not absolutely necessary for the process.

The heat input of the laser beam 2 into the laser light-transmissive metal layers or metal cores of the pigment platelets causes the metal components of the pigment to melt and contract in a liquid state, presumably thanks to the high surface tension. Presumably because of this surface tension, the more or less spherical remnants 5 of the platelets 4 solidify in a much more compact form than the original platelets, which, in contrast to the problem representation in FIG. 1, comparatively hardly exhibit any more hiding power and scattering capacities with each other, and therefore hardly reflect light and microwaves any more, because the pigment-containing matrix in the lasered area behaves less like a metal mirror and more like a permeable dielectric.

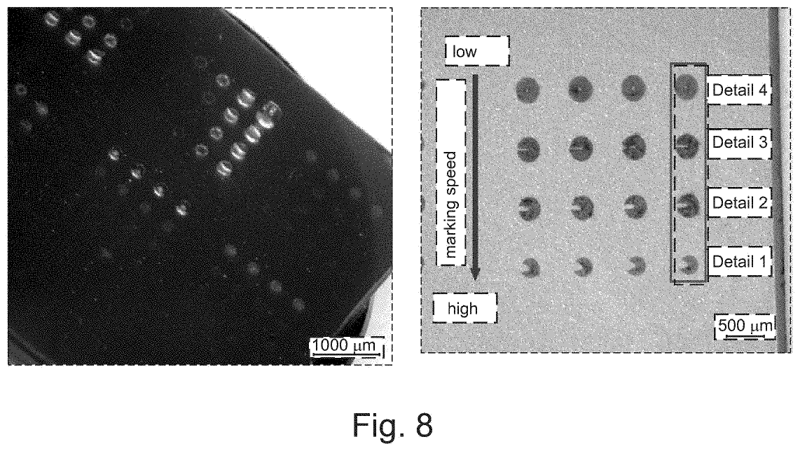

The magnification of an area lasered according to the invention shown in FIG. 8 shows that although the silvery/mirror pigments still appear intact outside the area, they appear as if they have disappeared in the treated area, even below the surface in the right-hand image, because the process according to the invention has made them almost spherical and they have almost completely lost their hiding power.

Nd-YAG near-infrared (NIR) laser radiation at 1064 nm has proven to be particularly advantageous for the process because the absorption A=1−R−T of the laser light by the thin metal layer is especially high at this wavelength. However, in the case of certain colored or NIR-absorbing matrix materials or certain NIR-absorbing pigment coatings that would absorb this wavelength too strongly, frequency-doubled (532 nm, green laser beam) or frequency-tripled (355 nm, UV laser beam) wavelengths also prove more advantageous in special cases because the thin metal layers of the pigments that are essential to the invention can absorb the laser beam energy almost as well at this shorter wavelength. A fiber laser (e.g., short-pulsed, Q-switch) or a flash tube (e.g., xenon) could also be used as another form of energy input.

Matrix materials that could be used include: ABS—Acrylonitrile butadiene styrene, ASA, PS, San-Styrene polymers, Duroplasts, Fluor polymers, PA—Polyamides, PBT—Polybutylene terephthalate, PC—Polycar-bonate, PE—Polyethylenes, PET—Polyethylene terephthalate, PETG—Polyethyl-ene terepthalate, PMMA—Polymethyl methacrylate, POM—Polyacetal, PP—Po-lypropylene, Silicone, TPE—Thermoplastic elastomers, TPU—Thermoplastic elastomers.

Depending on the chemical composition of the pigment structure and the chemical properties of the matrix components, exothermic chemical reactions also occur during the process. For example, the filler calcium carbonate decomposes under laser irradiation and releases carbon dioxide, reacting favorably with the liquid metal. The formation of these chemical reactions indirectly triggered by the laser irradiation, although not absolutely necessary to advantageously solve the tasks of the invention, are, depending on the structure of the pigments, particularly advantageous for the process according to the invention, because the laser beam may not have to be so strong, and for this reason has less negative influence on the matrix, since part of the melting energy is supplied by the reaction. The temperatures generated by these reactions can then advantageously liquefy other more heat-resistant pigment components, such as protective layers of silica or interference layers of iron oxide as well.

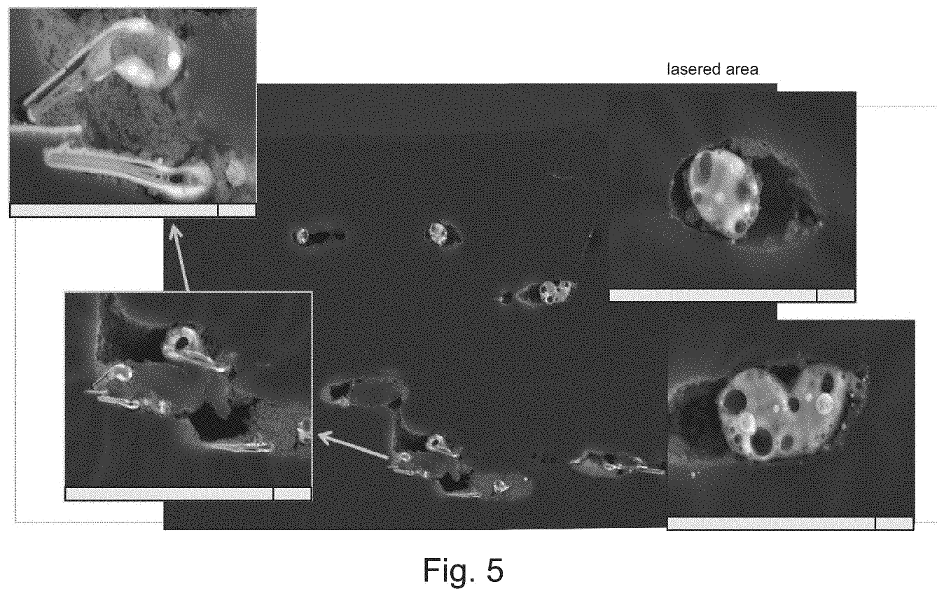

Surprisingly, it has been observed that their liquid remnants can also contract compactly due to surface tension and trigger desirable thermite reactions, which residually transform the reflective metal components of the metal effect pigments into transparent oxides such as alumina. The illustrated details on the right side of FIG. 5 show that the method according to the invention allows all layers of a pigment to mix and react together in a more compact vesicle-containing magma.

FIG. 5 shows an enlarged cross section of a basecoat of a vehicle treated according to the invention with transformed multilayer pigments with a thin aluminum core. On the left side of FIG. 5, only partially transformed pigments are visible in cross-section, giving an idea of their original layer structure.

Among them are also particularly heat-resistant protective layers of silicon dioxide, which were melted by the method according to the invention and reacted chemically with the thin aluminum core in a thermite reaction.

Very high temperatures are required to initiate a thermite reaction with the liquefied aluminum, which is difficult to ignite.

X-ray analysis of the magma-like resolidified pigment residues surprisingly showed that appreciable amounts of calcium atoms were also present in this magma, as if they had co-reacted. Since the pigments did not originally contain calcium, it is strongly suspected that the calcium atoms may have been components of common fillers in the plastic matrix, and that these fillers may have chemically reacted with the components of the pigment (mainly the thin aluminum core, coated with silica), especially since one of the most commonly used fillers, calcium carbonate/calcite/chalk, is known to decompose under laser light into quicklime and carbon dioxide.

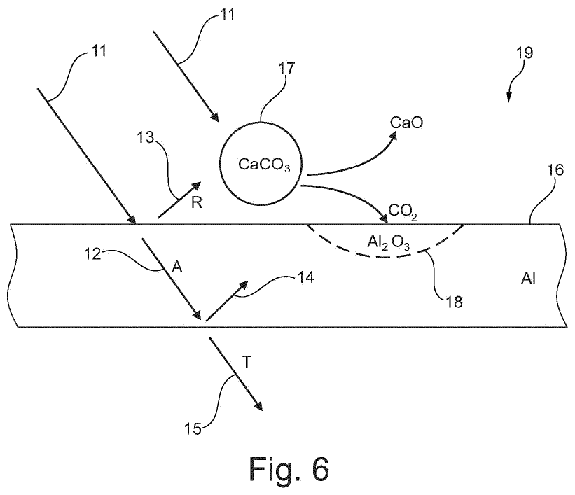

Although the exact possible chemical interactions have not yet been conclusively clarified, FIG. 6 shows how the fillers can contribute to the formation of very high reaction temperatures with the pigments in one version.

However, at the heart of the matter is the finding that by selecting a suitable energy input, the metal core is melted and the surface tension causes a change in the shape factor of the pigment/particle. Neither the coating of the pigment, nor additional fillers in the paint or matrix are a prerequisite for the method and, according to some embodiments, are even not provided/desired, for example to reduce foaming of the pigment residue by intrinsic chemical reactions.

By selectively converting the pigments in one (partial) area (pattern) of the body part and keeping the unchanged pigments in another (partial) area, it is possible to provide a radar permeable area in a paint and at the same time to be flexible in terms of design and to allow everything from partial transparency in the visible area to an optically invisible structuring. Thus, according to a preferred embodiment of the invention, a decoupling between a desired transparency for radar waves and a transparency in the visible range for optically visible effects (design) takes place by means of a patterning/structuring (by applying energy to selective areas of the body part—for example by selective laser scanning or by applying a mask).

A translucent matrix 19 contains pigment platelets with thin metal layers or metal cores 16. Where appropriate, the matrix 19 contains conventional heat-sensitive filler particles 17, for example CaCO3 (calcite/chalk/calcium carbonate), which may be statistically located adjacent to a metal core. The use of CaCO3 in plastics, among other things, to improve laser markability is known per se. For example, U.S. Pat. No. 5,075,195 from 1991 discloses a laser marking based on aluminum effect pigments (with a metal oxide protective layer on a metal core) in a polypropylene matrix using chalk/calcite (═CaCO₃) as filler.

According to the invention, a laser beam 11 is irradiated through the matrix to liquefy the thin metal layers or metal cores 16—which are indeed partially transparent—by partial absorption A of the energy of the laser beam, where the absorbed energy fraction A of the beam can be calculated as the difference of the energy arriving on the platelet and the reflected (R) and transmitted (T) energy fractions A=1−R−T.

It is believed that the surface tension of the liquid metal forces a drastic change in the shape factor of the pigment as the liquefied metal contracts as a spherical droplet. After cooling and solidification of this metal droplet, much less surface area is covered than by the original core. This drastically reduced hiding power of the resolidified remnants of the original metal core of the pigment platelets in the laser-irradiated area results not only in increased transparency or translucency, but also in substantially improved transmission for microwaves, due to a reduction in the scattering capacitances caused by platelet overlap.

If a thermally decomposable filler particle 17 is in the vicinity of the pigment, it is also believed that the liquefied metal will react exothermically with the decomposition products of the filler particles, transforming at least in part into transparent and dielectric metal oxides that further increase the transparency of the irradiated areas. For example, very finely ground calcium carbonate particles are often used as fillers in basecoats and masterbatches. Under laser light, the basically thermally unstable calcium carbonate is decomposed into quicklime and carbon dioxide. The latter then reacts strongly exothermically with the surface 18 of the liquid metal, forming a semi-transparent metal/metal oxide sponge with CO gas bubbles, as can be seen in FIG. 5, top right, and as explained in the dissertation by D. C. Curran (“Aluminium Foam Production using Calcium Carbonate as a Foaming Agent” University of Cambridge, 2004) under “Foaming mechanisms”, page 173.

The gas bubbles contained in the spongy pigment residues are surrounded by a 40-100 nm thick (and transparent) metal oxide film due to the reaction dynamics.

This aluminum-carbon dioxide reaction 2 Al+3 CO₂==>Al₂O₃+3 CO, which can be used, for example, in rocket engines for Mars spacecraft (Rossi et al “Combustion of Aluminum Particles in Carbon Dioxide”, Combustion Science and Technology Volume 164, pages 209-237, 2001), is known to produce very high temperatures (>3000° C.), especially with liquid aluminum metal. Such a high temperature would probably be sufficient to ignite a thermite reaction between a protective layer of silicon dioxide and the aluminum core, which would then probably convert the rest of the aluminum metal into transparent aluminum dioxide.

If the core of the metal effect pigment is alternatively or additionally surrounded by other layers, for example highly refracting chalcogenide layers such as iron oxide, to achieve interference color effects, the aluminum-carbon dioxide reaction fueled by the calcite decomposition can also lead to the ignition of a thermite reaction between the aluminum core and the chalcogenide layers, completely transforming the thin aluminum core into transparent oxides, permanently changing the interference color effects in the laser irradiated region and leading to even better radar wave transparency.

In the prior art, there is a widespread technical and safety prejudice among metal effect pigment manufacturers that thermite reactions are a fire hazard and always a serious drawback that must be suppressed at all costs.

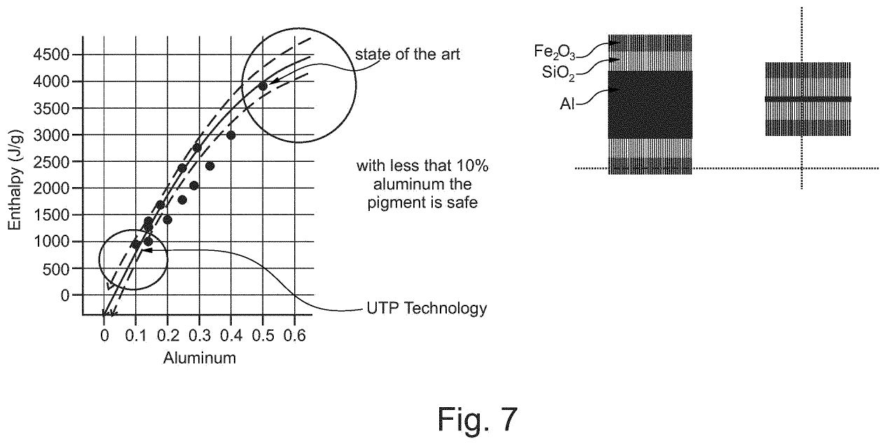

As shown quantitatively in the graph of FIG. 7, the free enthalpy of pigments with thin cores according to the invention, preferably VMP cores, is so low that there is hardly any fire hazard and the pigment can be stored and transported safely in dry conditions without any special fire safety requirements.

The UTPs (Ultra Thin Pigments) preferred for the invention with, if necessary, chalcogenide interference layers (for example of Fe2O3) have a VMP aluminum core which, even in the case of an intentionally (by laser marking according to the invention) or unintentionally triggered thermite reaction, enables much better fire safety than the classic interference pigments, which are at high risk of thermite reaction because of the thicker aluminum core and which therefore have to be stoichiometrically color-limited for safety reasons. This lower risk of UTPs allows a wider interference color range, which can also be marked transparent and/or microwave-transmissive by laser even better and cheaper.

The present invention also relates to the products of the process, e.g. items painted with metallic effect pigments, such as plastic body parts that have been made more transparent to radar waves, items such as cosmetic bottles, banknotes or automotive controls that are subsequently marked or micro-marked with transparent, translucent or backlightable symbols (in a mirror-like coating) that are transparent to radar waves and/or light waves.

Likewise, the present invention relates to the use of metal effect pigments suitable for the process, interference metal effect pigments, metal-containing particles, as well as printing inks, lacquers, masterbatches and articles which contain such suitable particles, or pigments, and are optimized for application of the process. Optimized also, for example, by the use of suitable laser-sensitive fillers that promote a chemical reaction or physical deformation of the metal content of the pigments or metal-containing particles.

The process differs from conventional laser marking in that the transmission for electromagnetic waves of normally reflective metal-effect pigment surfaces is permanently increased by pigment shrinkage caused by the laser beam, whereby the pigment platelets are modified either by direct melting and/or by triggering an auxiliary chemical reaction in such a way that their metal core is at least partially melted, chemically transformed and/or destroyed. The treated surfaces can thus become more transparent or translucent.

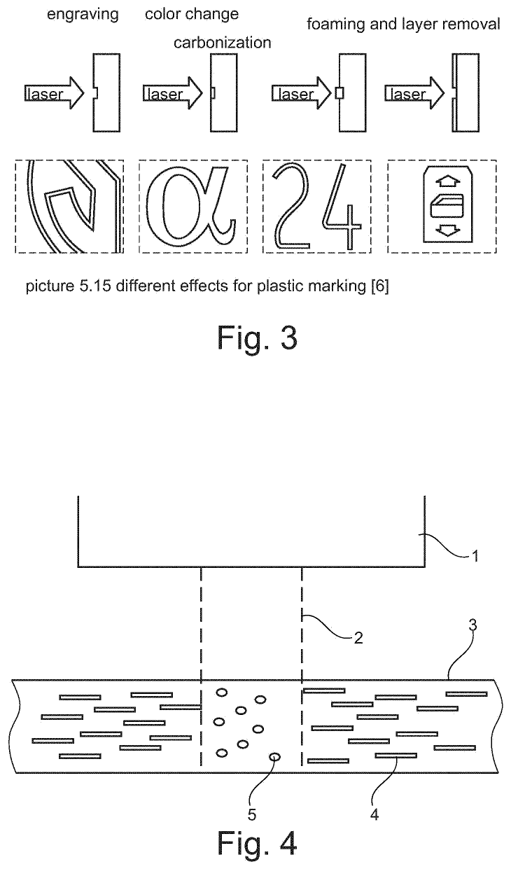

For comparison, FIG. 3 (state of the art), from the book “Surface Technology” by Dr. Feist, shows the objective of conventional laser marking methods.

While these techniques have been known for decades to be able to mark pigment coatings in depth (and to do so by local charring, gasification or chemical modification of the matrix of the basecoat) without damaging a clearcoat or plastic layer in front of it, to date no laser marking method is known whose purpose is to physically or chemically modify the metal-effect pigments themselves so that they no longer interfere with microwave radiation without impairing the protective effect and/or optical properties of the coating too much.

In contrast to the present invention, the processes known from the prior art (engraving, color change and carbonization, foaming and layer removal) do not result in any physical or chemical pigment transformation; rather, conventional laser marking methods are based on the transformation of the polymer matrix. Neither a reduction in the hiding power of the individual pigments nor an increase in transmission with respect to electromagnetic waves is the object of the conventional laser marking techniques.

However, for best results, the method according to the invention requires metal effect pigment flakes or interference metal effect pigment flakes with thin metal cores or layers, preferably vacuum metallized pigments with a core of low melting point metals, such as tin, aluminum, indium, tin-indium alloy, zinc, lead, Ag, Cu, etc.

Further preferably, the core may be so thin that it is partially transparent to the laser light, so that the energy of the laser beam can be optimally absorbed inside the core, even in part by multiple reflections, while the amount of metal that must be deformed or transformed remains sufficiently small. In any case, the core must be thin enough that the energy introduced is sufficient to melt the core.

Naturally, however, the desired optical impression of the metallized coating layer is the primary factor in selecting the optimum core thickness: thinner aluminum cores reflect little light (low R-value in the following table), and therefore appear rather dark, while thicker ones (from about 320 Angstroms/32 nm thickness, over 90% of the light is reflected) appear brighter silvery-metallic.

In Table IV from “Optical Constants and Reflectance and Transmittance of Evaporated Aluminum in the Visible and Ultraviolet”, Journal of the optical society of America, G. Hass and J. E. Waylonis, July 1961, Vol. 51 no. 7, July 1961

TABLE IV
Calculated reflectance and transmittance of A1 film evaoprated under optimum conditions
onto transparent substrates of [symbol] 1.5 for various wavelengths as a function of film thickness.
(Calculated values agree with directly measured ones for film thickness > 100; back surface
antireflected.)

| Film | Wavelength (m [symbol] ) | | | | | | | | | |
|---|---|---|---|---|---|---|---|---|---|---|
| thickkness | 220 | | 300 | | 400 | | 540 | | 650 | |
| (A) | R % | T % | R % | T % | R % | T % | R % | T % | R % | T % |
| 40 | 14 | 52 | 19 | 74 | 25 | 65 | 33 | 51 | 38 | 42 |
| 80 | 33 | 60 | 43 | 47 | 52 | 36 | 60 | 24 | 63 | 18 |
| 120 | 32 | 40 | 62 | 17 | 70 | 10 | 74 | 12 | 75 | 0 |
| 160 | 67 | 25 | 74 | 16 | 79 | 11 | 81 | 7 | 82 | 5 |
| 200 | 76.3 | 12.2 | 81.5 | 9.1 | 84.9 | 5.9 | 85.6 | 3.5 | 85.4 | 2.0 |
| 240 | 82.4 | 9.1 | 86.0 | 5.1 | 88.1 | 3.3 | 88.1 | 2.0 | 87.5 | 1.4 |
| 280 | 86.2 | 5.4 | 88.4 | 3.1 | 90.0 | 1.9 | 89.5 | 1.1 | 88.8 | 0.8 |
| 320 | 88.5 | 3.2 | 90.0 | 1.8 | 91.1 | 1.1 | 90.4 | 0.5 | 89.8 | 0.4 |
| 360 | 89.6 | 1.0 | 90.0 | 1.0 | 91.7 | 0.6 | 90.9 | 0.4 | 90.0 | 0.3 |
| 400 | 90.6 | 1.1 | 91.4 | 0.5 | 92.1 | 0.4 | 91.2 | 0.2 | 90.3 | 0.2 |
| 440 | 91.5 | 0.3 | 92.0 | 0.1 | 92.5 | <0.1 | 91.5 | <0.1 | 90.6 | <0.1 |

[symbol]

indicates data missing or illegible when filed

reflectance and transmittance of thin aluminum films at different wavelengths are given. Although the light absorption, which is important for quantifying the heating of the core by a laser beam, has not been explicitly given in the table, the absorption of a thin aluminum layer or core can be determined from the table using the formula A=1−R−T. In the thickness range 8 to 32 nm, it is relatively favorable at 10% or higher. In the thickness range 8-16 nm, depending on the wavelength, the absorption is most favorable, in some cases above 15%, which provides relatively strong heating of the aluminum core with relatively little laser energy.

Aluminum cores, for example, are partially transparent to light from an Nd-YAG laser (1064 nm, frequency doubled at 532 nm or frequency tripled at 355 nm) up to about 40 nm thickness (>0.2% transmission at 40 nm thickness according to the table), and are best suited to absorb laser light at a thickness of 8 to 32 nm, preferably 10 to 20 nm, and are particularly well suited for the method of the present invention in this thickness range.

Aluminum cores thicker than 40 nm still absorb almost unchanged 10% of the laser energy, but it is obvious that the bulkier core heats up less rapidly with the same absorbed energy, so that any physical melting effects or any chemical reactions are less favored with thicker cores. Multiple reflections of the laser beam within the pigment also tend to play less of a role in overall heating for thicker cores than for thinner cores.

For these reasons, it is suspected, and experiments conducted have confirmed, that thicker cores are less suitable for the process of the invention because they reflect the laser light back into the matrix with less loss and also heat up less rapidly anyway because of their larger volume.

When triggering an exothermic chemical reaction in the pigment as desired by the invention, such as a thermite reaction (for example, by laser ignition of an interference metal pigment with an aluminum core and iron oxide coating), thicker metal cores would also react more violently and dangerously because of the larger amount of metal, creating an increased fire hazard. With the thin aluminum cores, an ignited thermite reaction no longer propagates uncontrollably from pigment to pigment.

According to previous safety prejudices regarding the fire hazard of pigments based on aluminum nanoparticles, these must be classified as potentially hazardous materials, especially if they come into contact with certain metal oxides such as iron oxide or titanium oxide in stoichiometric quantities (as evidence of these prejudices, see in particular WO2005/049739 on Eckart, according to which the feasible color range is limited because of the fire hazard, and Schlenk EP3283573B1, according to which the thermite reaction can be suppressed at a certain ratio of aluminum to the rest. These limitations no longer apply to thin aluminum cores. Thus, the interference metal effect pigments with thin cores suitable for the method according to the invention are more advantageous in at least two respects: substantially broader color range and high fire safety, see FIG. 5.

Although a number of possible physical and chemical explanations for the formation of transparency by laser irradiation are suspected for various pigment structure types, it has not yet been conclusively clarified which are the most important.

In the case of pigments consisting only of thin aluminum metal, possibly with even thinner protective layers, it is assumed, among other things, that the pigments heated by the laser are either simply melted (Al melting point 660° C.) and, because of the surface tension of the liquid aluminum, essentially lose their very flat shape factor and solidify again in an approximately spherical form, as shown schematically in FIG. 4 schematically shown, or chemically react with laser light-sensitive fillers of the plastic matrix (calcite/chalk CaCO₃) according to the reaction shown in FIG. 5 at about 800° C., and re-solidify as aluminum/alumina/quicklime/CO₂/CO in a spongy and nearly spherical form, as shown on the right side of FIG. 6, with aluminum being at least partly converted into alumina. In an improved embodiment, MgCO₃/dolomite is proposed as a filler in a paint layer/plastic instead of calcite/chalk.

The drastic improvement of the light and microwave transmission of the treated area is therefore not only due to the reduction of the hiding power of the metal effect pigments suggested in FIG. 4 and experimentally visible in FIG. 8 (in the treated area of FIG. 8, most of the pigments have shrunk in such a way that only some are visible at all), but also because alumina as a reaction product of the transformation of the nucleus is basically transparent to light, because quicklime appears white, and because these reaction products can no longer reflect microwaves. On the one hand, because they are no longer electrically conductive, and on the other hand, because without electrically conductive platelet components, the phenomenon of boundary polarization schematically explained in FIG. 1 can no longer exist, whereby the scattering capacity effects unfavorable for microwave transmission have almost completely disappeared.

On the left side of FIG. 5, a partially melted pigment is shown which appears to have no characteristics of a chemical reaction (hardly any intermixing of the layers).

On the right side of FIG. 5, on the other hand, an apparently foamed pigment residue is shown, which exhibits several gas bubbles like a sponge, as if the aluminum had reacted with a well-known plastic filler often used as an additional agent, such as calcium carbonate. Such an aluminum foam reaction is described, among others, in “production of aluminum foam and the effect of calcium carbonate as a foaming agent” by Aboraia et al, Journal of Engineering Sciences, Vol. 39 no. 2, March 2011, as well as in the PhD thesis by D. C. Curran in the University of Cambridge in 2004: “Aluminium foam production using calcium carbonate as a foaming agent” https://www.repository.cam.ac.uk/handle/1810/252945; also in the context of carbon dioxide see in particular the paragraph “Foaming mechanisms”, page 173-174.

In the two phenomena, i.e. physical melting and/or chemical reaction, which are compatible with the observed experimental results, the shape factor of the original pigment platelet shrinks drastically, and as a result the boundary polarization and scattering capacitance caused by pigment overlap is also drastically reduced.

As a calculation example, a vacuum-metallized pigment of 8 micrometers in diameter (corresponding to a hiding power of about 50 square micrometers in area) and 12 nanometers in thickness is described, the metal core of which consists of, for example, aluminum or an aluminum alloy in metallic form. The purity of the metal is relatively unimportant to the invention. The pigment is melted by a laser, and in liquid form contracts again as droplets due to surface tension, as is also illustrated experimentally in the image detail of FIG. 5, top left, and then solidifies again in quasi-spherical form. The volume of the latter, both in its original plate form and in droplet form, is unchanged at 0.603 cubic micrometers, corresponding to a sphere of about 1.04 micrometers in diameter, with one of only 0.85 square micrometers.

The hiding power of a pigment treated in this way is therefore about 60 times smaller than that of the original pigment. Therefore, the pigment overlaps in the area treated by the laser for radar waves are now much smaller, or there is hardly any overlap between the shrunken pigment residues. Incidentally, due to the reduced hiding power by a factor of 60, the transparency of the pigment would be much higher, because the now heavily shrunk pigment areas hardly cover the background. This transparency effect is also enhanced by two further phenomena: firstly, more appreciable translucency effects result from stronger scattering around the smaller particle; and secondly, any chemical reaction of the metal core in the liquid state with its environment (usually an oxidation) generally produces more transparent reaction products, which make the core remnants more translucent.

A description of the details shown in FIG. 5 on the right, where several gas bubbles have formed within the otherwise largely homogeneous appearing magma of the pigment remnants after laser irradiation, substantiates several assumptions and conclusions about the course of pigment transformation. First, very high temperatures were probably reached, because even the laser-transparent silicon dioxide (melting point 1710° C.) of the protective coating melted completely.

Second, the gas bubbles within the pigment remnants can probably only be explained if not only a purely physical melting took place, but also a chemical reaction that produced a gas, and in appreciable quantities. Since the main pigment components (aluminum and silica) can only react with each other as a thermite reaction, and since such a reaction cannot generate a gas, the observed gas bubbles are likely to be seen as important evidence that instead or in addition another chemical reaction took place, which in the course of the reaction was capable of generating many gas bubbles inside the pigment remnants. A common filler of the plastic matrix such as calcium carbonate, which is known as a foaming agent for liquid aluminum due to its temperature-induced decomposition into carbon dioxide and quicklime, and the fact that the combustion of liquid aluminum in carbon dioxide allows extremely high combustion temperatures up to 3000° C., which could well liquefy silicon dioxide and trigger a thermit reaction of the same with aluminum allows the hypothesis according to FIG. 6 that calcium carbonate is to be regarded as a reagent and that the bubbles probably contain a mixture of unreacted carbon dioxide and carbon monoxide.

### Test Equipment, Test Samples and Test Results.

The near-infrared laser source used is a conventional computer-controlled desktop laser marking device with a pulsed Nd-YAG laser at 1064 nm with a fixed 15 KHz pulse frequency, equipped with a suitable scanning unit, adjustment unit and sample holder.

The system allows the output of almost arbitrary 2D patterns onto the test samples with variable pulse spacings (pulse spacings from 6 to 36 micrometers have generally been used) and defined beam power attenuations from 6 watts to about one tenth of a watt.

Since the appropriate pulse spacing and pulse power are largely pigment and matrix dependent, the appropriate laser parameters must be determined on a case-by-case basis.

The test samples consist of flat polypropylene sheets, and were equipped with various metal effect pigments and interference metal effect pigments with thin aluminum cores according to the invention.

Polypropylene sheets with various metal effect pigments in diverse concentrations were provided as test objects, either directly in the plastic or in an applied basecoat, as commonly used in the automotive industry. Some of the samples were also provided with a clearcoat over the basecoat, as is common in automotive coatings.

Pigments not according to the invention were tested as comparative examples, such as pearlescent pigments and metallic effect pigments with thicker metal cores, and it was confirmed that the thin metal core is indeed essential to the process according to the invention.

In the case of pigments not according to the invention, such as pearlescent pigments from the Kuncai company, no laser parameters could be found that produced any transparency effect: No transparency effects were produced, and if the laser irradiation was too strong, burns of the matrix were also produced.

Laser irradiation through the clearcoat to achieve transparency has proved more difficult in most samples according to the invention, probably due to laser losses in the clearcoat. Accordingly, this has only partially led to the desired transparency result.

FIG. 8 shows how the appropriate Nd-YAG laser parameters for each pigment/matrix/substrate combination were determined by experimental arrays with different marking speeds (pulse spacing), laser powers and waiting times after each polygon train.

An array of concentric rings has been chosen as the trajectory. At higher power and lower marking speed, a light foaming of the matrix is visible on the test sample in the image on the left in FIG. 8 and can also be felt haptically, in addition to the transparency achieved.

Such an additional haptic effect may well be advantageous or desirable, for example, in the production of backlit lasered symbols on control elements made of metal-effect pigmented plastics, including control elements with lasered symbols that must be operated at night in a car, boat or airplane cockpit, a computer keyboard or a cell phone, and that must be both seen and haptically felt for safety reasons.

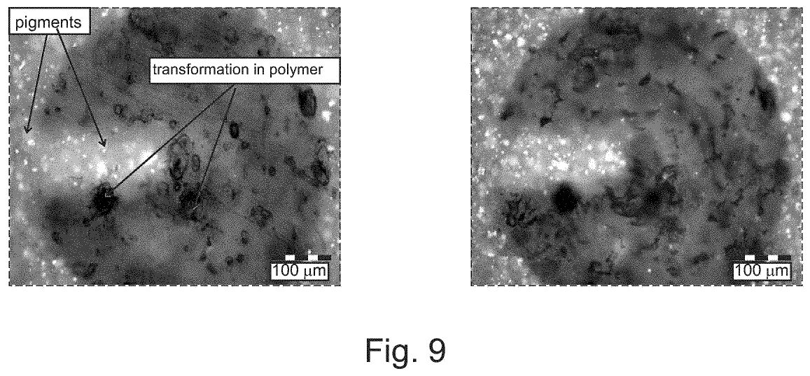

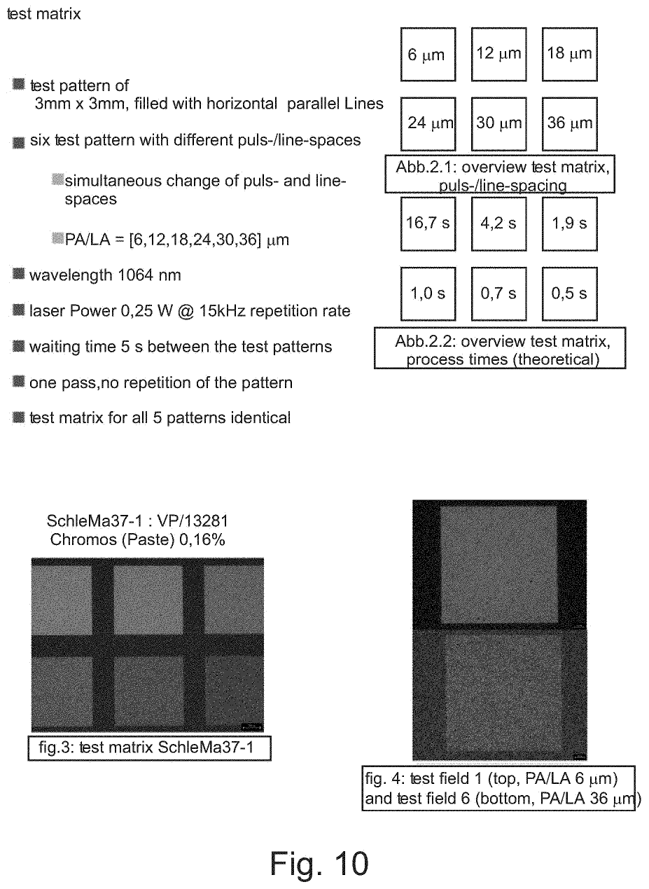

These experiments confirmed that the lasered areas become transparent or translucent when using the metal effect pigments with thin metal core, and that the mirror-like effect in the lasered areas is destroyed. This can be seen clearly, in particular, on the highly magnified detailed view of an area of FIG. 8 in the image on the right of FIG. 9, in which the individual metal effect pigments have become visible due to the magnification.

It has been shown that a beam power of 0.25 watts at 15 KHz is sufficient in most cases to produce the transparency/translucency effect of the invention and the corresponding reduction in reflectance.

At higher powers, increased charring of the matrix can occur, as can be seen in isolated cases in FIG. 9.

If higher concentrations of foaming agents (for example calcium carbonate, which decomposes under laser light) or stronger laser irradiation are used, the irradiated area can also be given a tactile haptic effect in addition to local transparency.

The enlargement of the metal-effect pigmented surface of the test object after laser treatment, shown in FIG. 9 in the image on the left with focusing at the surface, and in the image on the right below the surface, shows that in the laser-treated area, apart from some laser-induced charring, reflective pigments are hardly visible any more, nor are they visible below the surface, because due to the melting and surface tension of the liquid core they have shrunk together under laser irradiation to such an extent that their hiding power has been practically destroyed.

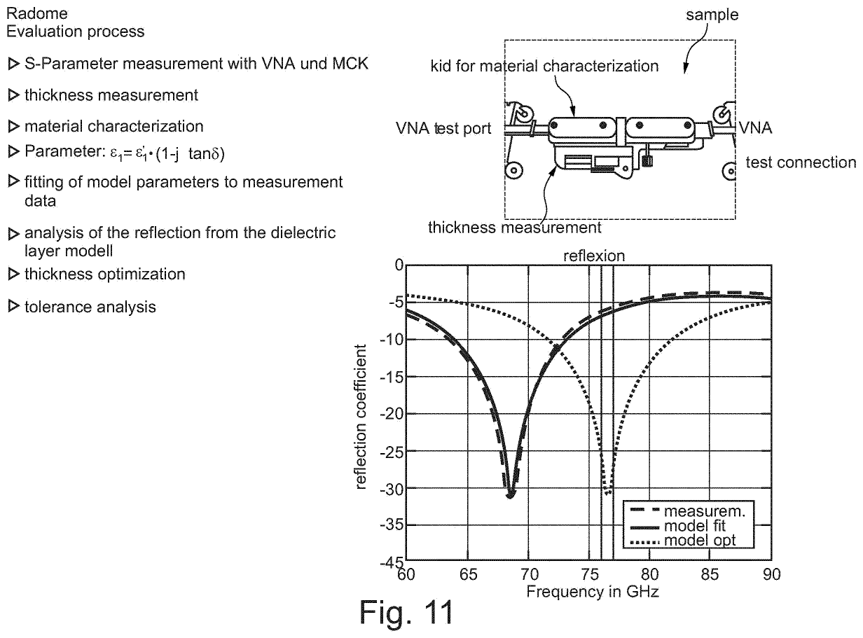

Also because of this shrinkage of the lasered pigments, the pigment overlaps and their scattering capacitances, which are problematic for microwave transmission, have practically disappeared and which provided a high reflection coefficient in untreated areas. This is another reason why the laser-treated area does not reflect light or microwaves, as can be confirmed with the network analysis-test setup shown in FIG. 11.

FIG. 10 shows the principles, parameters and results of a more mature experimental test matrix with square scanned test patches at 0.25 W laser power at 15 kHz pulse repetition rate and a wavelength of 1064 nm and based on the experimental results of laser parameters optimized according to FIG. 8.

The pulse spacings on the six test patches are 6, 12, 18, 24, 30 and 36 micrometers, with the transparency achieved decreasing accordingly (the irradiated patches naturally become darker with increasing laser pulse spacing) while the writing speed increases; at 36 micrometers, the grid lines and individual irradiation points become visible; five pigment types and concentrations were tested.

Shown are the results of a low-concentration sample (Chromos pigment, manufacturer Schlenk), which looks particularly dark and hardly reflective even in the non-lasered areas because the pigment is characterized by a particularly thin metallic core of aluminum, 0.16% pigment content).

Five samples were successfully tested, including a pure aluminum Decomet pigment from the Schlenk company without a silicon protective layer, i.e. without the possibility of using the additional reaction heat of a thermite reaction. All exhibited similar optical transparency gradations.

The microwave reflectance properties of the test samples were determined using the waveguide materials characterization kit (MCK) shown in FIG. 11 by measuring the reflection coefficient of a test sample between two waveguides, each connected to a vector network analyzer (VNA).

For a laser-patterned paint sample of an interference metal effect pigment Zenexo Golden Shine according to the invention (pigment structure: thin aluminum metal layer, then enveloping silica protective layer, then at least one interference layer of iron oxide, interference color gold), the reflection coefficient decreased as expected from −5 dB in the unlasered state to −15 dB after lasering at a relatively large and noticeable laser pulse spacing of about 0.1 millimeter.

From the measurement of the reflection coefficients, the transmission properties can also be determined. −15 dB reflection coefficient (S11) means that very little microwave energy is reflected from the laser-treated paint on the test object, and almost all of the radar energy is transmitted through the test object unobstructed.

A waveguide measurement can quantitatively measure how the laser treatment improves the transmission of radar waves from the painted surface, and how much the unwanted reflection on the paint is suppressed by the laser irradiation.

In FIG. 13, the properties of a radome slit profile (Y-slit matrix radome, lasered transparent into an object painted with Zenexo Golden Shine pigment) were shown.

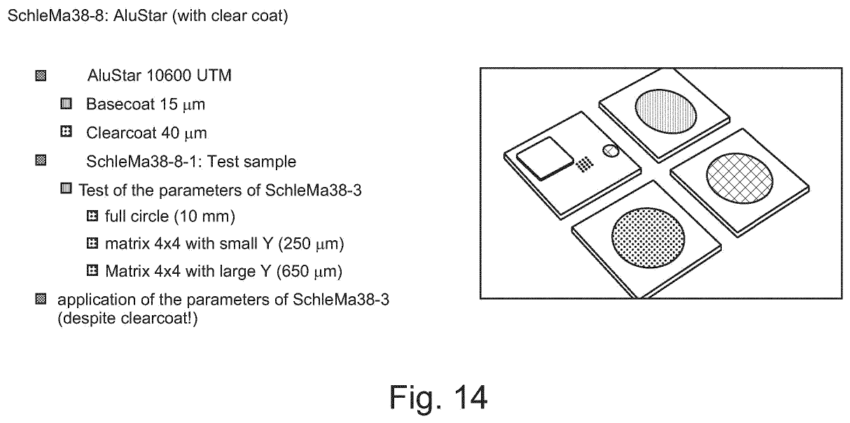

In FIG. 14, the properties of a Y-slot matrix radome, lasered transparent through 40 microns of clear varnish into an object painted with the silvery pigment Alustar, were shown.

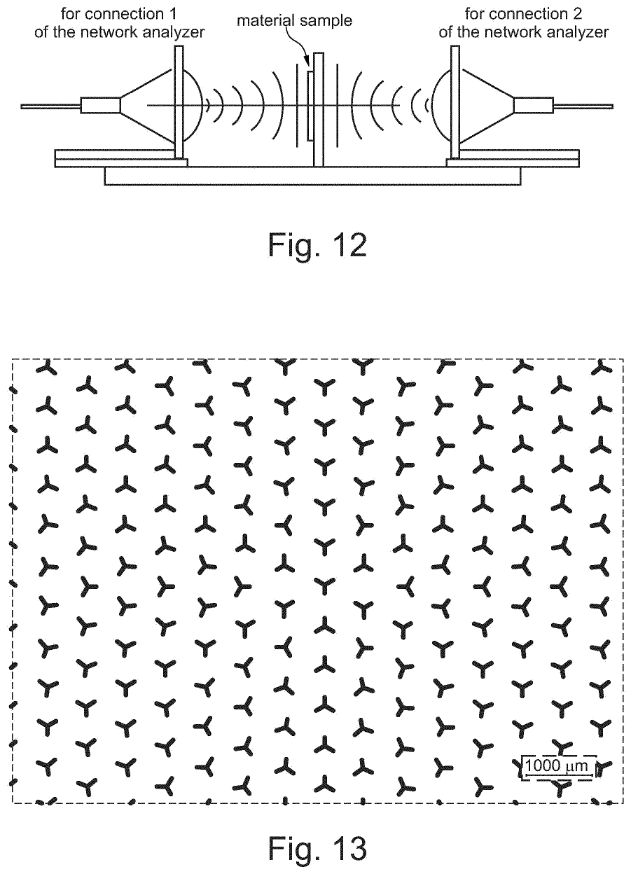

FIG. 12 shows the measurement of the free space reflection coefficient of a test sample, such as a metal painted car body part, using a Vector Network Analyzer (VNA) and a Free Space Material Characterization Kit (MCK). Source of illustration: Michel Joussemet “novel devices and Material Characterization at mm-wave and Teraherz”, Agilent Technologies, available on the Internet at https://www.keysight.com/upload/cmc_upload/All/noveldevices.pdf.

The Y-slot radome profiles shown in FIG. 13 and FIG. 14 come from the theory of slot antennae, although this theory naturally applies to slots in homogeneous, well-conducting metal sheets. Slot radomes are not, of course, the only possible applications of the invention in the microwave, radar, or 5G telecommunication domains.

Part of the invention is also to make transmitting or receiving antennas or antenna elements from laser-cut metal-effect pigment coating on plastic, as well as to make relatively inexpensive radar-absorbing structures for flying objects.

The overall teachings of antenna theory and radiation absorbing structures can be extrapolated to metal effect pigmented surfaces, especially in the microwave range, when VMP pigments and a suitable, particularly low loss dielectric matrix are used, because these pigments are particularly smooth from the manufacturing process and have good overlap properties.

The Y-slot and full-circle radome profiles shown in FIG. 13 and FIG. 14 were lasered for testing with several effect pigment paints and then measured experimentally under millimeter beams (in a frequency range around 76 GHz, corresponding to 4 mm wavelength).

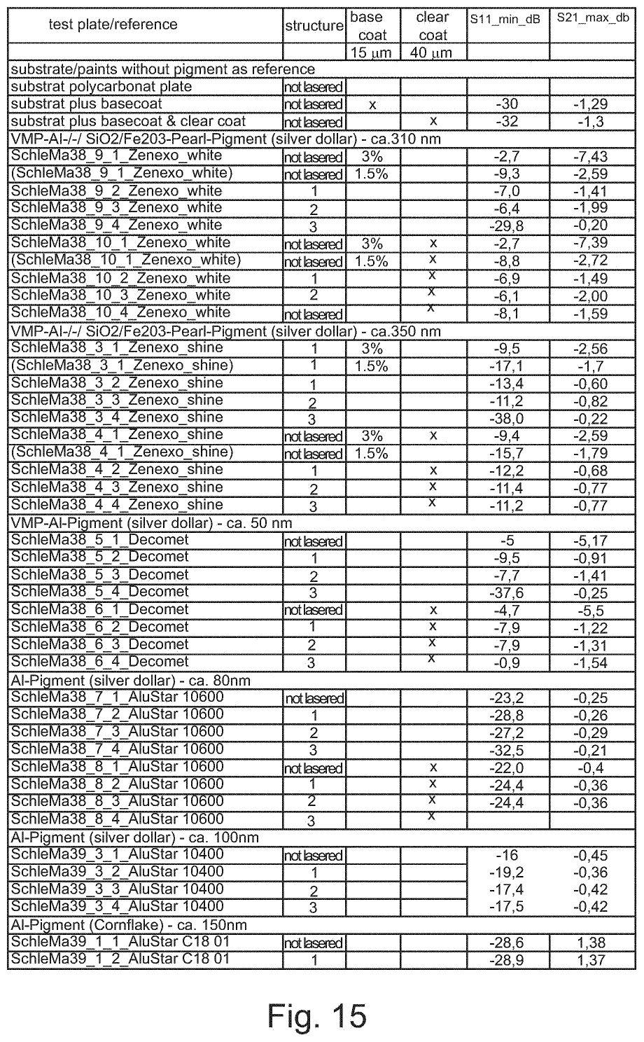

The measurement results of painted polycarbonate sheets as shown in FIG. 15 allow a comparison with the non-lasered metal effect pigmented surfaces.

These measurement results show that for pigments (tests 38-1 to 38-7, aluminum thickness up to 80 nm), the laser treatments produce considerable effects in the reflection and transmission of millimeter waves. Especially for structure 3 (lasered full circle), the test results are almost as good as for polycarbonate plates without pigments.

Other important aspects of the invention can be formulated as follows:

It is an object of the invention to provide a method for permanently increasing the transparency, translucency or transmission for electromagnetic waves or other electromagnetic radiation of a substantially dielectric article or layer comprising metal-containing platelets or metal-coated particles, characterized in that the metal portion of the platelets or particles is preferably at most 80 nm thick, further preferably at most 30 nm thick, and that an energy input (light input or heat input, etc.), for example by a laser, is sufficient to increase the transparency, translucency or transmission for electromagnetic waves or other electromagnetic radiation.), for example by a laser, in order to achieve a permanent change in shape of the metallic portion and/or to trigger a chemical reaction of the metallic portion which substantially increases the transparency, translucency or transmission of the article or layer for electromagnetic waves.

Preferably, however, without causing damage to the dielectric layer or the article itself.

It is further an object of the present invention to provide any product of the method of increasing the transparency, translucency or transmission to electromagnetic waves of a substantially dielectric article.

1. A post-treatment method for increasing the transmission of radar waves in painted body parts, comprising the steps:
providing a painted body part containing metal effect pigments, interference metal effect pigments or metal-containing particles having at least in part a thin coherent metallic portion in metallic form,
providing a laser light,
characterized in that the laser light is activated to trigger at least a melting of the metallic portion in metallic form of the pigments or particles, as a result of which the shape factor of the pigments or particles changes and thereby increases the transmission of radar waves without destroying the coating layer and/or impairing the optical properties of the coating.

2. The method according to claim 1, wherein selectively areas of the painted body part are protected or spared (patterned) from the laser input, for example by selective laser scanning or by applying a mask.

3. The method according to claim 1, characterized in that a plurality of locally limited laser activations on the painted body part generates a pattern consisting of areas of changed pigments and areas of unchanged pigments.

4. The method according to claim 3, characterized in that the pattern increases the permeability or transmission property only for radar waves.

5. The method according to claim 2, wherein the selected pattern serves as a frequency-selective surface, for example for the production of radar absorbing materials (RAM).

6. The method according to claim 2, wherein the pattern is designed such that the paint layer forms an electromagnetically functional part of a slot antenna, radome, array antenna or wavelength selective absorbing surface.

7. The post-treatment method according to claim 1, characterized in that improved radio wave transmission, radar wave or millimeter wave transmission in a desired area of the body part is achieved by lasering a slot radome pattern or slot pattern into the paint layer.

8. The post-treatment method according to claim 7, characterized in that the pattern lasered into the paint layer is not or hardly perceivable to the human eye because the lasered lines of the slit radome pattern are less than one tenth of a millimeter wide.

9. The post-treatment method according to claim 1, characterized in that the thin coherent metallic portion in metallic form of the pigments is sufficiently thin to be partially transparent to the light of a laser used for the method, the laser having a wavelength between 10600 nm (CO₂ laser) and 266 nm (quadrupled frequency of an Nd-Yag laser), preferably between 1064 nm and 355 nm, and wherein the metallic portion is so thin that it is penetrated by at least 0.2% of the laser light at least one wavelength in the said wavelength range.

10. The post-treatment method according to claim 1, characterized in that the originally thin platelet or the thin metallic portion at least partially liquefies and re-solidifies in a sphere-like form.

11. The post-treatment method according to claim 1, characterized in that the metallic portion in metallic form of the pigments reacts by participation or partial absorption of the light input by means of an exothermic chemical reaction with further constituents of the pigment and/or with laser light-sensitive fillers of the matrix in which the pigment is embedded.

12. The post-treatment method according to claim 1, characterized in that the metallic portion in metallic form is a vacuum-metallized pigment, or has a vacuum-metallized core or layer, preferably with a maximum thickness of the metallic core or layer of below 80 nm, preferably below 32 nm, more preferably below 27 nm, still more preferably below 25 nm, and most preferably between 8 nm and 17 nm.

13. The post-treatment method according to claim 1, characterized in that the use of the method reduces the light wave reflectance or albedo perpendicular to the pigment surface by at least 6 dB, preferably 10 db, further preferably 12 dB, and most preferably 20 db, wherein “light waves” also includes infrared or ultraviolet waves, as long as the measured light wavelength is smaller than the diameter of the untreated pigment.

14. The post-treatment method according to claim 7, characterized in that the radio or radar wave reflectance or reflection scattering parameter (S11) or albedo perpendicular to the pigment surface is reduced by at least 6 dB, preferably 10 db, further preferably 12 dB, and most preferably 20 db by using the method.

15. The post-treatment method according to claim 7, characterized in that in the practice of the method the radio wave transmission, radar wave or millimeter wave transmission, of the pigmented surface of the treated object and for at least one light wavelength in the IR, visible light or UV range is increased by at least 6 dB, preferably 10 db, further preferably 12 dB, and most preferably 20 db.

16. The post-treatment method according to claim 1, wherein the metallic portion consists in metallic form of a metal or alloy with a relatively low melting point, preferably tin, zinc, lead, silver, copper, or more preferably aluminum, indium, tin-indium alloy.

17. The post-treatment method according to claim 1, wherein a part of the metallic portion in metallic form reacts exothermically with a metal oxide layer of the metal-containing particle or pigment and the metallic portion is at least partially oxidized (thermite reaction).

18. The post-treatment method according to claim 1, wherein the laser light activation in at least one pigment or metal-containing particle causes directly or indirectly by surface tension a reduction in its outer surface area by a factor of 10, preferably 20, further advantageously 30 and even more advantageously 60, resulting in a corresponding reduction in the hiding power of the pigment, which increases transparency and radio wave transmission.

19. A painted body part or paint layer containing at least one converted pigment or metal-containing particle which has been converted according to claim 1 without the paint layer being destroyed and/or the optical properties of the paint being impaired at this location.

20. The painted body part or paint layer according to claim 19, wherein the layer/matrix containing the pigment/particle comprises polyimide, polystyrene, polyethylene, fluoropolymers such as Teflon, further preferably of polymethacrylimide or a mixture thereof.

21. A convertible particle, for example platelets, preferably metal effect pigment particles, for use in a process according to claim 1, wherein the particle comprises at least the following.
a first metal in metallic form; and
a first oxide coating the first metal (with or without intermediate layers).
